(19) United States
(12) Patent Application Publication
(10) Pub. No.: US 2004/0268417 A1
(43) Pub. Date: Dec. 30, 2004

(54) System and method for providing enhanced hot key functionality

(76) Inventors: James Harold Gray, Ellijay, GA (US); Thomas Jefferson Brothers, Gainesville, GA (US); William Randolph Matz, Atlanta, GA (US)

Correspondence Address: BELLSOUTH CORPORATION, P.O. BOX 2903, MINNEAPOLIS, MN, 55402-0903, US

(21) Appl. No.: 10/611,453

(22) Filed: Jun. 30, 2003

(51) Int. Cl. H04N 7/173; H04N 7/16

(52) U.S. Cl. 725/135; 725/136; 725/110; 725/112; 725/113

(57) ABSTRACT

According to one aspect of the present invention, a method of providing enhanced hot key functionality comprises receiving a hot key signal from an interactive television service provider's network. The hot key signal indicates availability and a location of alternate content. A determination is made whether the hot key signal is relevant to a user viewing original content from the interactive television service provider. Responsive to determining the hot key signal is relevant to the user, an indication that the hot key signal has been received is displayed on the screen. Responsive to receiving an indication that the hot key is accepted, a determination is made regarding a location on a screen for the alternate content and the original content and the alternate content are displayed in a Picture-In-Picture mode.

### RELATED APPLICATIONS

This application is related to co-pending application number Ser. No. ______ filed on Jun. 30, 2003.

### FIELD OF THE INVENTION

The various embodiments of the invention disclosed herein relate generally to the field of interactive television. More particularly, these embodiments relate to providing enhanced hot key functionality.

### BACKGROUND OF THE INVENTION

Advances in telecommunications and computing technology have led to the use of interactive television (TV) services on a large scale. Where such services are available, users are not only able to access television content by passively receiving it, but are also beginning to interact with the service providers by communicating requests and/or commands to the service providers. These requests and/or commands may be communicated to the service provider via the same path over which the programming services are provided or even via other paths.

Interactive television may be provided over any number of paths, including coaxial cable or optical fiber, hybrid fiber/coaxial, or any other suitable path that accommodates sufficient bandwidth for desired video channels as well as other telecommunications services. Content providers may include, for example, providers of over-the-air programming such as commercial television stations, cable programming such as weather, travel and entertainment channels, game channels, and other interactive services of various types.

Generally, TV service provides a user or users with a variety of options such as: traditional broadcast and cable television programming; video services, such as pay-per-view (PPV), near video-on-demand (NVOD), video-on-demand (VOD), promo channels, electronic program guides, etc.; cable delivered PC-based services; and interactive services through the use of a combination of compression and digital video technologies. TV services may also provide menuing capabilities and upstream signaling from users to service providers.

The combination of broadcast and interactive applications over interactive TV (e.g., interactive content) creates a possible mode of communication in which a user, if informed of the availability of alternate interactive content relating to a subject matter of interest, may invoke the alternate content to investigate that subject matter more thoroughly and according to his or her own tastes. However, television viewers, who are accustomed to choosing at will between the available transmitted channels with instantaneous results, will expect to be informed of the alternate content in a convenient and timely manner and to pass from one medium to another seamlessly.

### SUMMARY OF THE INVENTION

A method and apparatus are described that provide enhanced hot key functionality. According to one aspect of the present invention, the method comprises receiving a hot key signal from an interactive television service provider's network. The hot key signal indicates availability and a location of alternate content. A determination is made whether the hot key signal is relevant to a user viewing original content from the interactive television service provider. Responsive to determining the hot key signal is relevant to the user, an indication that the hot key signal has been received is displayed on the screen. Responsive to receiving an indication that the hot key is accepted, a determination is made regarding a location on a screen for the alternate content and the original content and the alternate content are displayed in a Picture-In-Picture mode.

According to another aspect of the present invention, a method and system comprise receiving a hot key signal from an interactive television service provider's network. The hot key signal indicates availability and a location of alternate content and contains information providing details regarding the alternate content. A determination is made whether the hot key signal is relevant to a user viewing original content from the interactive television service provider. Responsive to determining the hot key signal is relevant to the user, an indication that the hot key signal has been received is displaying on the screen.

According to yet another aspect of the present invention, a method and system comprise receiving a hot key signal from an interactive television service provider's network. The hot key signal indicates availability and a location of alternate content and contains data representing a hot key form. A determination is made whether the hot key signal is relevant to a user viewing original content from the interactive television service provider. Responsive to determining the hot key signal is relevant to the user, an indication that the hot key signal has been received is displayed on the screen, the indication corresponding to the data representing the hot key form.

According to a further aspect of the present invention, a method and system comprise receiving a hot key signal from an interactive television service provider's network. The hot key signal indicates availability and a location of alternate content. A determination is made whether the hot key signal is relevant to a user viewing original content from the interactive television service provider. Responsive to determining the hot key signal is relevant to the user, an indication that the hot key signal has been received is displayed on the screen. Responsive to receiving an indication that the hot key is accepted, a menu of options for handling the alternate content is displayed on the screen.

According to a further aspect of the present invention, a method and system comprise receiving a hot key signal from an interactive television service provider's network. The hot key signal indicates availability and a location of alternate content. A determination is made whether the hot key signal is relevant to a user viewing original content from the interactive television service provider. Responsive to determining the hot key signal is relevant to the user, an indication that the hot key signal has been received is displayed on the screen. Responsive to receiving an indication that the hot key is accepted, the alternate content is presented to the user. Responsive to the user finishing the alternate content, a menu of options for returning from the alternate content is displayed on the screen.

Other features of the present invention will be apparent from the accompanying drawings and from the detailed description that follows.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIGS. 1A-1D illustrate a television displaying a picture containing a hot key for informing a user of available alternate content and redirecting the user to the alternate content responsive to selection of the embedded hot key according to one embodiment of the present invention;

FIGS. 2A-2D illustrate a television displaying a picture containing a hot key for informing a user of available alternate content and displaying content in a picture-in-picture mode responsive to selection of the embedded hot key according to one embodiment of the present invention;

FIGS. 3A-3D illustrate a television displaying a picture containing a hot key for informing a user of available alternate content and presenting, responsive to selection of the embedded hot key, a menu of user options for handling available alternate content responsive to selection of the embedded hot key according to one embodiment of the present invention;

FIGS. 4A-4D illustrate a television displaying a picture containing alternate content selected in response to a hot key signal and presenting a menu of return options when the user is finished viewing the alternate content according to one embodiment of the present invention;

FIG. 5 is a block diagram illustrating an exemplary network over which interactive television signals containing embedded hot key signals may be transmitted according to one embodiment of the present invention;

FIG. 6 is a block diagram of a head-end and data center system where hot key signals may be added to a transmitted signal according to one embodiment of the present invention;

FIG. 7 is a flowchart illustrating head-end and data center processing for adding hot key signals to a transmitted signal according to one embodiment of the present invention;

FIG. 8 is a diagram illustrating one possible format for a hot key data packet according to one embodiment of the present invention;

FIG. 9 is a block diagram of a user side system to redirect a user to alternate content responsive to selection of an embedded hot key according to one embodiment of the present invention;

FIG. 10 is a flow chart illustrating processing on a user side system for presenting alternate content in a picture-in-picture mode according to one embodiment of the present invention;

FIG. 11 is a flowchart illustrating processing on a user side system for providing hot key information messages according to one embodiment of the present invention;

FIG. 12 is a flowchart illustrating processing on a user side system for providing descriptive hot key forms according to one embodiment of the present invention;

FIG. 13 is a flowchart illustrating processing on a user side system for providing hot key user options capability according to one embodiment of the present invention; and

FIG. 14 is a flowchart illustrating processing on a user side system for providing user directed return capability according to one embodiment of the present invention.

### DETAILED DESCRIPTION OF THE INVENTION

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

Embodiments of the present invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, Compact Disk Read-Only Memories (CD-ROMs), and magneto-optical disks, Read-Only Memories (ROMs), Random Access Memories (RAMs), Erasable Programmable Read-Only Memories (EPROMs), Electronically Erasable Programmable Read-Only Memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

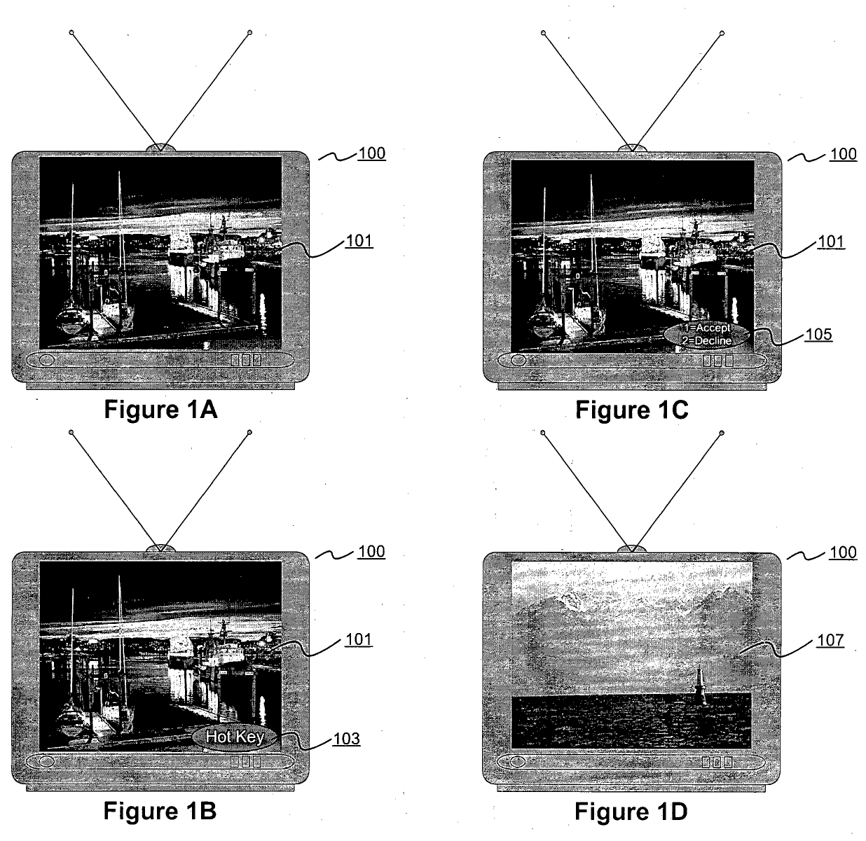

FIGS. 1A-1D illustrate a television displaying a picture containing a hot key for informing a user of available alternate content and redirecting the user to the alternate content responsive to selection of the embedded hot key according to one embodiment of the present invention. These figures represent respectively a process of viewing content, receiving a hot key, accepting a hot key, and redirecting to alternate content.

Specifically, FIG. 1A illustrates an example of viewing content. Here, a video program 101 is being displayed on television 100. Alternatively, a user may be viewing other types of interactive TV content such as pay-per-view video content, interactive games, etc.

FIG. 1B illustrates an example of receiving a hot key. In this example, the user is tuned to the same video program 101 on television 100 as in the previous example of FIG. 1A. However, in this example an icon 103 or other graphic has been displayed to indicate to the user that a hot key has been received. The hot key indicates that alternate content is available for the user's consumption. According to one embodiment of the present invention, the alternate content may be in the form of another video program with content related to the video program 101 being viewed by the user.

FIG. 1C illustrates an example of accepting a hot key. In this example, the user is tuned to the same video program 101 as in FIGS. 1A and 1B. Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Of course, other methods of accepting or declining the alternate content may be used. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Pressing the hot key button may be a manner in which the user accepts the alternate content and is redirected to that content without further interaction from the user. According to another embodiment, the user may decline the alternate content by taking no action at all. That is, after some time period during which no action is taken by the user to accept the alternate content, the hot key may simply time out and expire. Various other methods of accepting or declining the alternate content may also be used.

Regardless of the exact operation used to accept the alternate content, FIG. 1D illustrates redirecting a user to alternate content responsive to the hot key being accepted. According to one embodiment of the present invention, the alternate content may be another video program with content related to the video program 101 being viewed by the user. Therefore, television 100 in FIG. 1D illustrates an alternate video program 107 being displayed. According to one embodiment of the present invention, the alternate video program 107 may present content related to the original content the user was viewing. For example, if the user was viewing a television program related to travel, the alternate video program may also be related to travel.

According to yet another embodiment of the present invention, the alternate video program may be commercial in nature. For example, the television program may be related to sports. In such a case, the alternate video program may be a pay-per-view sporting event of the same type or an advertisement for an upcoming pay-per-view event. In another example, the alternate video program may be an “infomercial” selling merchandise related to some aspect of the original video content.

Therefore, content providers and/or service providers may be able to sell hot keys just as they currently sell time for commercial spots. For example, a provider of pay-per-view video content may wish to purchase from a content provider a hot key that redirects users to his content or an advertisement of upcoming events during a television program related to that content. Alternatively, content providers may charge users to receive a hot key service or even to block some or all hot key signals. Content providers and/or service providers may thus be able to realize an additional source of revenue.

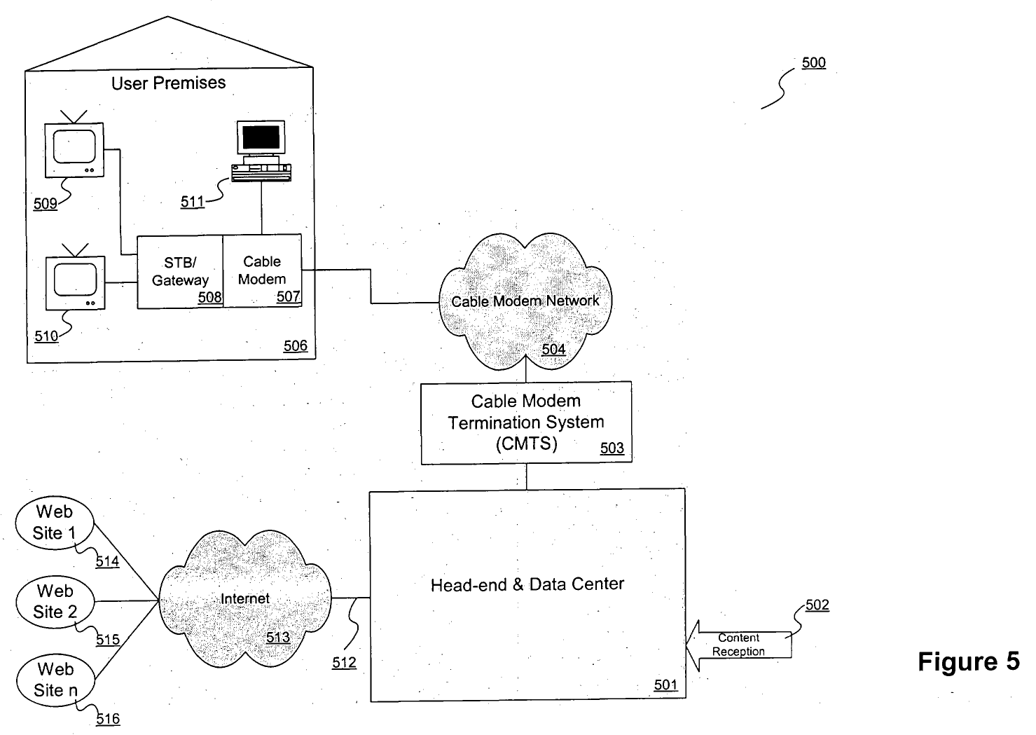

As will be described below with reference to FIG. 5, a system over which interactive television signals containing embedded hot key signals may be transmitted according to various embodiments of the present invention may be implemented over different types of networks. These different types of networks include, but are not limited to, cable, satellite, Fiber-to-the-Curb (FTTC), Fiber-to-the-House (FTTH), Very high speed Digital Subscriber Line (VDSL), and others.

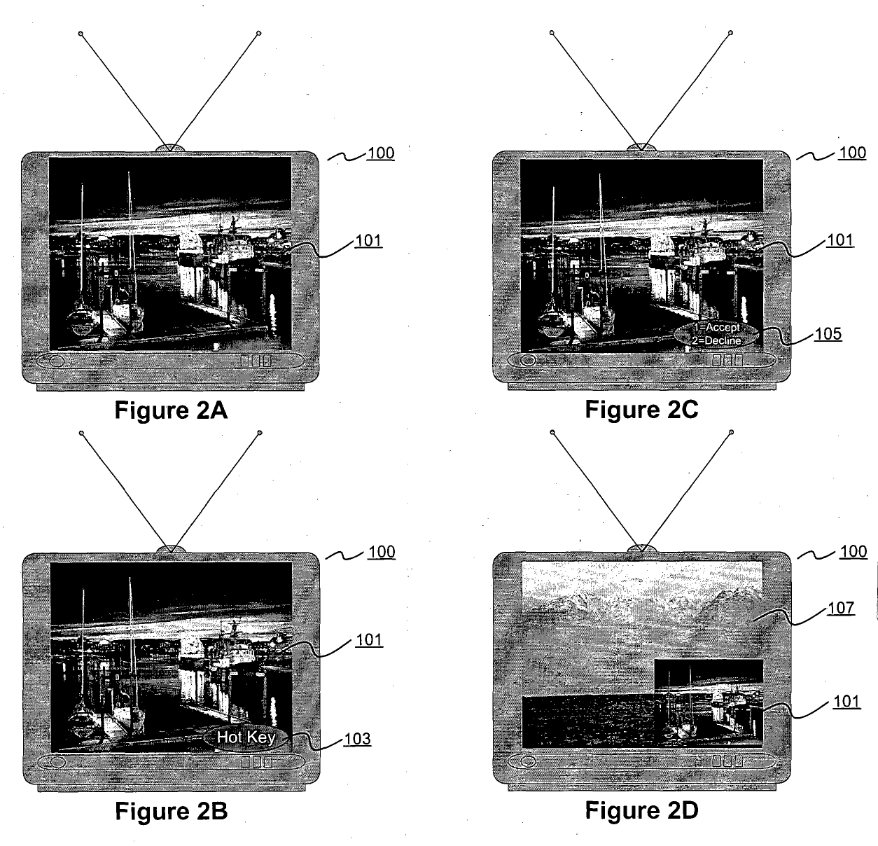

FIGS. 2A-2D illustrate a television displaying a picture containing a hot key for informing a user of available alternate content and displaying content in a picture-in-picture mode responsive to selection of the embedded hot key according to one embodiment of the present invention. As in the previous example, these figures represent respectively a process of viewing content, receiving a hot key, accepting a hot key, and redirecting to alternate content. In this example, however, the alternate content, if selected, may be viewed in a picture-in-picture (PIP) mode.

Specifically, FIG. 2A illustrates an example of viewing content. Here, a video program 101 is being displayed on television 100. Alternatively, a user may be viewing other types of interactive TV content such as pay-per-view video content, interactive games, etc.

FIG. 2B illustrates an example of receiving a hot key. In this example, the user is tuned to the same video program 101 on television 100 as in the previous example of FIG. 2A. However, in this example an icon 103 or other graphic has been displayed to indicate to the user that a hot key has been received. The hot key indicates that alternate content is available for the user's consumption. According to one embodiment of the present invention, the alternate content may be in the form of a web site with content related to the video program 101 being viewed by the user.

FIG. 2C illustrates an example of accepting a hot key. In this example, the user is tuned to the same video program 101 as in FIGS. 2A and 2B. Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Of course, other methods of accepting or declining the alternate content may be used. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Pressing the hot key button may be a manner in which the user accepts the alternate content and is redirected to that content without further interaction from the user. According to another embodiment, the user may decline the alternate content by taking no action at all. That is, after some time period during which no action is taken by the user to accept the alternate content, the hot key may simply time out and expire. Various other methods of accepting or declining the alternate content may also be used.

Regardless of the exact operation used to accept the alternate content, FIG. 2D illustrates displaying alternate content and original content in a PIP mode responsive to the hot key being accepted. In this example television 100 illustrates the alternate content 107 being displayed on the main portion of the display and the original content 101 being displayed in the PIP. Alternatively, the original content 101 may be displayed in the main portion of the display and alternate content 107 may be displayed in the PIP. Exactly how the alternate content is displayed may be determined at the users terminal device. The terminal device may default to one method, may be configured by the user to perform another method, may query the user to determine his preference prior to displaying the alternate content, or may use another method to determine which content should be displayed in the different portions of the display.

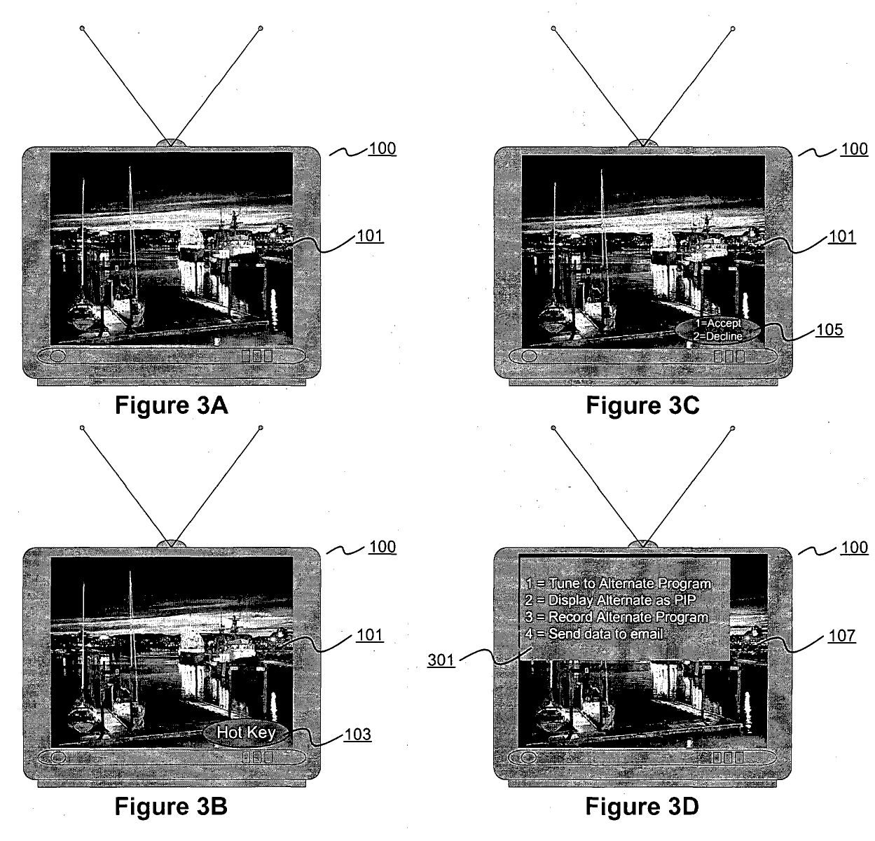

FIGS. 3A-3D illustrate a television displaying a picture containing a hot key for informing a user of available alternate content and presenting, responsive to selection of the embedded hot key, a menu of user options for handling available alternate content responsive to selection of the embedded hot key according to one embodiment of the present invention. As in the previous example, these figures represent respectively a process of viewing content, receiving a hot key, accepting a hot key, and redirecting to alternate content. In this example, however, the alternate content, if selected, may be viewed in a picture-in-picture (PIP) mode.

Specifically, FIG. 3A illustrates an example of viewing content. Here, a video program 101 is being displayed on television 100. Alternatively, a user may be viewing other types of interactive TV content such as pay-per-view video content, interactive games, etc.

FIG. 3B illustrates an example of receiving a hot key. In this example, the user is tuned to the same video program 101 on television 100 as in the previous example of FIG. 3A. However, in this example an icon 103 or other graphic has been displayed to indicate to the user that a hot key has been received. The hot key indicates that alternate content is available for the user's consumption. According to one embodiment of the present invention, the alternate content may be in the form of a web site with content related to the video program 101 being viewed by the user.

FIG. 3C illustrates an example of accepting a hot key. In this example, the user is tuned to the same video program 101 as in FIGS. 3A and 3B. Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Of course, other methods of accepting or declining the alternate content may be used. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Pressing the hot key button may be a manner in which the user accepts the alternate content and is redirected to that content without further interaction from the user. According to another embodiment, the user may decline the alternate content by taking no action at all. That is, after some time period during which no action is taken by the user to accept the alternate content, the hot key may simply time out and expire. Various other methods of accepting or declining the alternate content may also be used.

Regardless of the exact operation used to accept the alternate content, FIG. 3D illustrates displaying a menu 301 of user options for handling the available alternate content. In this example, the menu 301 includes options to tune to and view the alternate program, display the alternate content in a PIP, record the alternate content, and request that the alternate content be sent to an email address. The exact options presented may vary widely. In some cases not all of these options may be presented. Alternatively, other options may be included. The exact options presented by menu 301 may be determined by the user's terminal device and may be configurable by the user. For example, if the user determines that he does not wish to have alternate content sent to an email address, he may chose to eliminate this option from menu 301 through a configuration routine of his terminal device.

After a user has finished consuming alternate content, a return process will typically be executed. In one embodiment, this return process may simply return to the original content. If the original content is no longer available, the process may simply return to the channel on which the alternate content was present. According to one embodiment of the present invention, the user's terminal device may execute a return process that includes presenting a plurality of option to the user in the form of a menu.

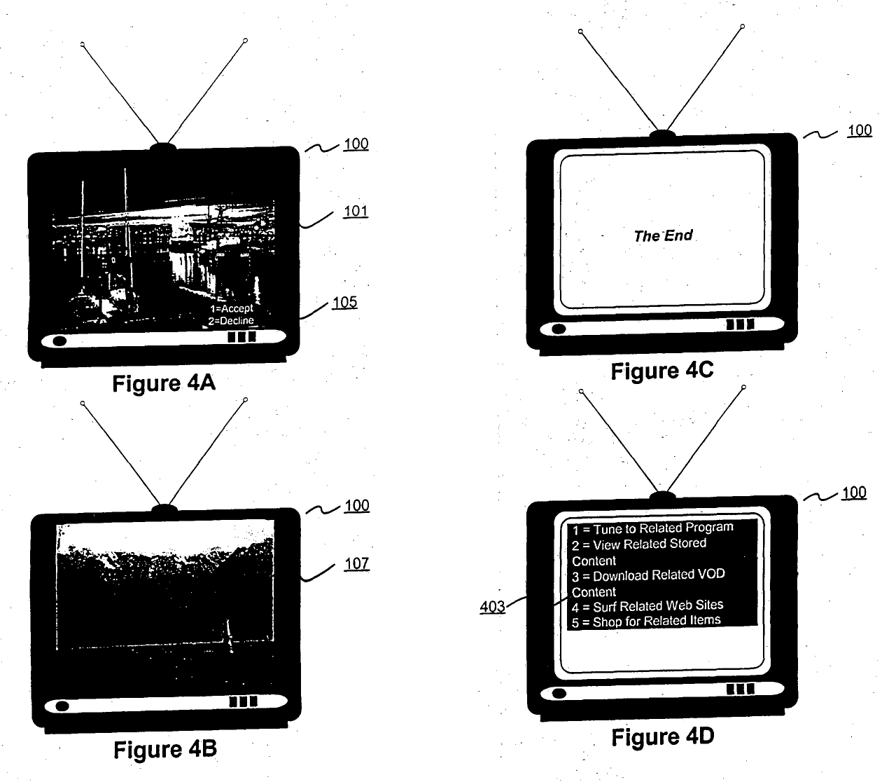

FIGS. 4A-4D illustrate a television displaying a picture containing alternate content selected in response to a hot key signal and presenting a menu of return options when the user is finished viewing the alternate content according to one embodiment of the present invention. FIG. 4A illustrates an example of accepting a hot key. In this example, the user is tuned to the same video program 101 on television 100 as in of the previous examples. Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Regardless of the exact operation used to accept the alternate content, FIG. 4B illustrates redirecting a user to alternate content responsive to the hot key being accepted. This example illustrates an alternate video program 107 being displayed. The user will then view the alternate content 107 until he is satisfied. For example, the user may end his viewing of the alternate content by pushing a button on the remote control. Alternatively, the alternate content may play to its end. Once the alternate content is finished as illustrate in FIG. 4C, a return process may be executed. In one embodiment, this return routine may present a plurality of option to the user in the form of a menu.

FIG. 4D illustrates one example of a return process menu. In this example, the menu includes options to tune to a related program, view related stored content, download related Video On Demand (VOD) content, surf related web sites, or shop for related items. The exact options presented may vary widely. In some cases not all of these options may be presented. Alternatively, other options may be included. The exact options presented by this menu may be determined by the user's terminal device and may be configurable by the user. For example, if the user determines that he does not wish to view VOD content, he may chose to eliminate this option from the menu through a configuration routine of his terminal device.

FIG. 5 is a block diagram illustrating an exemplary network over which interactive television signals containing embedded hot key signals may be transmitted according to one embodiment of the present invention. A system over which interactive television signals containing embedded hot key signals may be transmitted according to various embodiments of the present invention may be implemented on different types of networks. These different types of networks include, but are not limited to, cable, satellite, Fiber-to-the-Curb (FTTC), Fiber-to-the-House (FTTH), Very high speed Digital Subscriber Line (VDSL), and others.

The example illustrated in FIG. 5 shows, at a high-level, an architecture of a service provider's system 500 that includes head-end and data center 501, Cable Modem Termination System (CMTS) 503, cable modem network 504, and user premises 506 that also contains cable modem 507, Set Top Box (STB)/Gateway 508, one or more televisions 509 and 510, and possibly other devices such as personal computer (PC) 511.

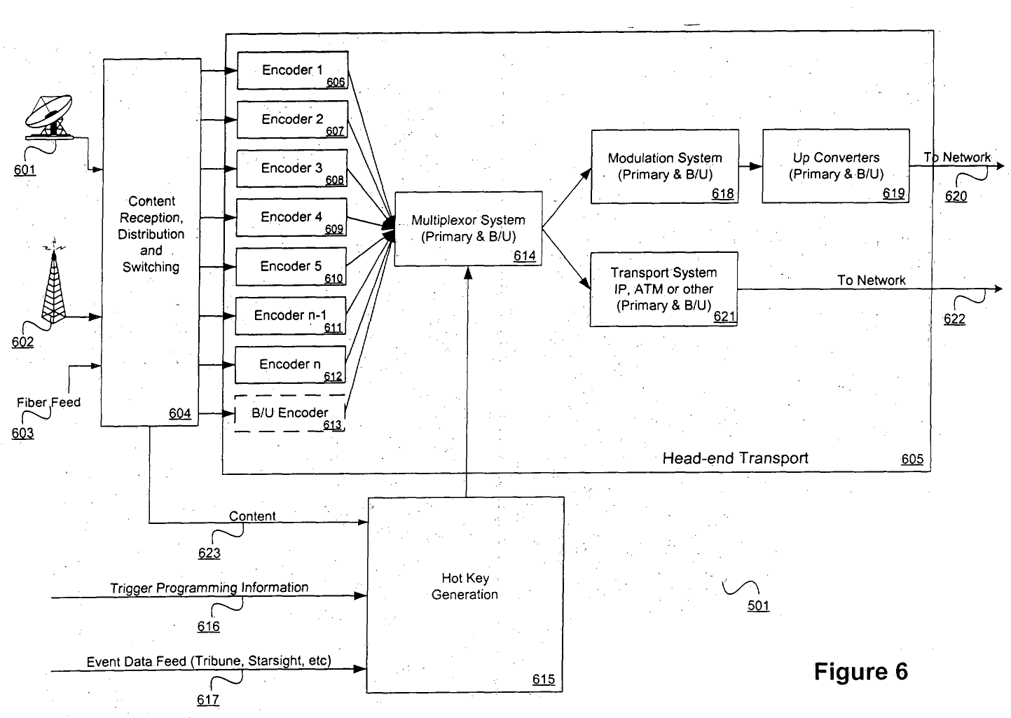

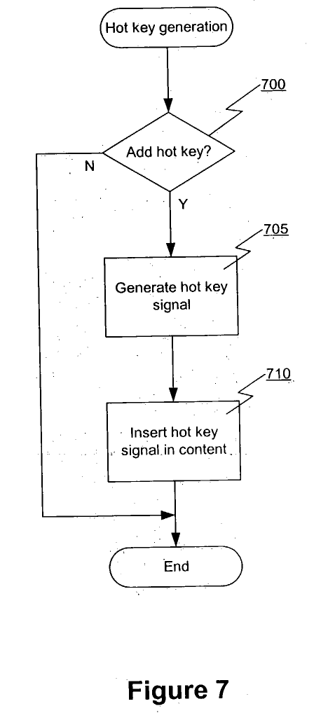

An interactive TV service provider typically operates and maintains a head-end and data center 501 equipped to receive signals 502 from one or more content providers. Content providers may be any original or secondary source of programming or information generally including, for example, interactive or non-interactive over-the-air programming such as commercial television stations, cable programming such as weather, travel and entertainment channels, game channels, and other interactive services of various types. Head-end and data center 501, after receiving content from one or more content providers, may then transmit the interactive content to users premises 506. Further details of the hardware comprising the head-end and data center 501 as well as the processing performed therein will be discussed below with reference to FIGS. 6 and 7.

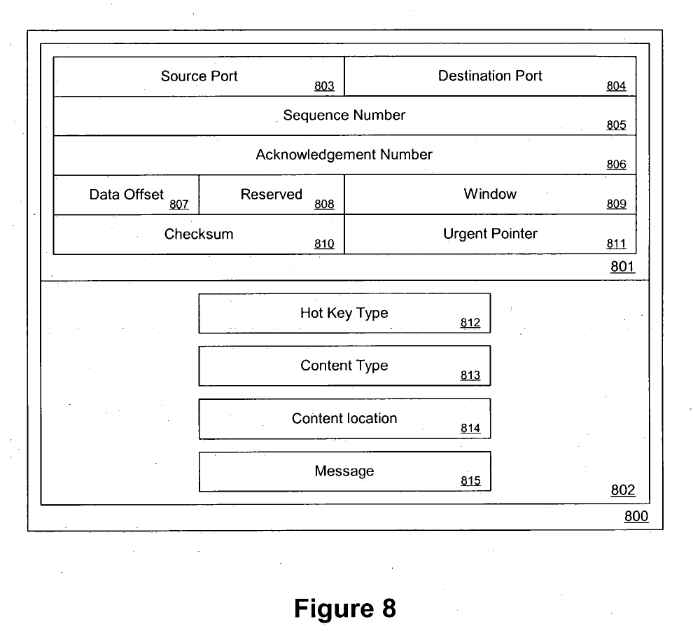

According to one embodiment of the present invention, hot key signals indicating the availability of alternate content may be provided to head-end and data center 501 along with and embedded in interactive TV signals 502 from the content providers. For example, the hot key signals may be generated at the content provider's location by an operations team when preparing and scheduling content for transmission to various service providers. As will be discussed below, interactive TV signals with these embedded hot key signals are transmitted from head-end and data center 501 and are received and used by STB/gateway 508 or PC 511 at user premises 506 to inform the user of the availability of alternate content and to guide the user to this content if he chooses to accept it. Details of the hot key signals will be discussed below with reference to FIG. 8.

According to another embodiment of the present invention, hot key signals indicating the availability of alternate content may be generated at head-end and data center 501. For example, the hot key signals may be generated at head-end and data center 501 by an operations team when preparing and scheduling content for transmission to users. As will be discussed below, these embedded hot key signals are transmitted from head-end and data center 501 and are received and used by STB/gateway 508 or PC 511 at user premises 506 to inform the user of the availability of alternate content and to guide the user to this content if he chooses to accept it.

In the example illustrated in FIG. 5, a signal carrying interactive TV content is transmitted from head-end and data center 501 through CMTS 503 and onto cable modem network 504. Typically, transmissions over cable modem network 504 may be made in a digital form. For example, the content may be transmitted as a Motion Pictures Experts Group Standard 2 (MPEG-2) data stream using a network protocol such as Internet Protocol (IP). Therefore, the content may be transmitted from head-end and data center 501 as IP data packets or in another similar format. One possible example of such a packet will be discussed below with reference to FIG. 8.

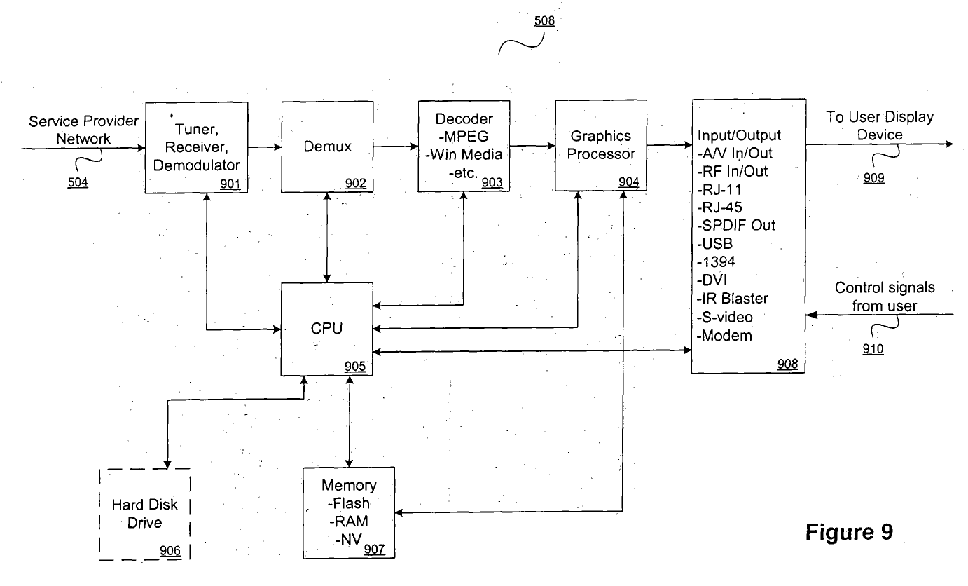

Regardless of the format of the transmission, a signal carrying the interactive TV content is received at user premises 506 via cable modem 507. Connected with cable modem 507 may be some form of terminal device. In the example illustrated by FIG. 5, two possible types of terminal devices, STB/Gateway 508 and PC 511 are shown. The terminal device, STB, Gateway, PC or other device, performs functions such as exchanging messages (including video-related data) over a network with head-end and data center 501, receiving messages from a user input device, such as a hand-held remote control unit or keyboard, translating video signals from a network-native format into a format that can be used by televisions 509 and 510 or other display devices, and providing a video signal to televisions 509 and 510 or other display devices. STB/Gateway 508 and PC 511 may also be capable of performing other functions, such as inserting alphanumeric or graphical information into the video stream in order to “overlay” that information on the video image, providing graphic or audio feedback to a user, or routing a traditional broadcast signal to a viewing device to which another STB is connected. Additional details of the hardware of STB/Gateway 508 and the processing performed therein will be discussed below with reference to FIGS. 9 through 14.

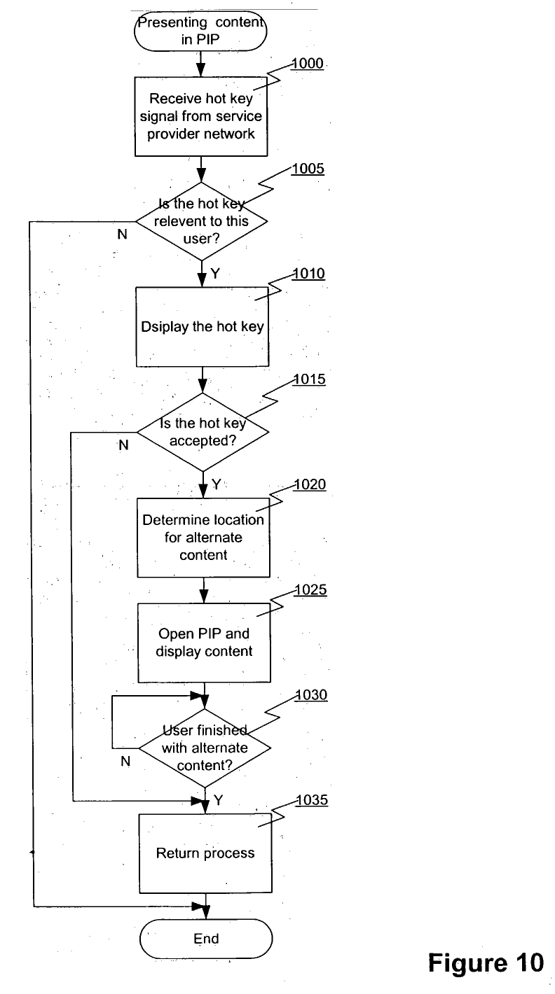

In use, STB/Gateway 508 or PC 511 may receive hot key signals embedded in the interactive TV signals by either the content providers or the service provider. STB/Gateway 508 or PC 511 may then notify the user of available alternate content as discussed above with reference to FIGS. 1 through 4. STB/Gateway 508 or PC 511 may then receive some form of user feedback indicating that the user accepts or declines the alternate content. If the user accepts the alternate content, STB/Gateway 508 or PC 511 may then redirect the user to this alternate content as will be discussed further below with reference to FIGS. 10 through 14.

According to one embodiment of the present invention, head-end and data center may also be connected with the Internet 513 or other network via a high-speed connection 512 such as a fiber optic connection to provide access to a number of web sites 514-516. Through this connection 512, head-end and data center 501 may supply content to users from one or more of the number of web sites 514-516 as well as provide other services such as email, instant messaging, etc.

FIG. 6 is a block diagram illustrating a head-end and data center system where hot key signals may be added to a broadcast signal according to one embodiment of the present invention. This example illustrates head-end and data center system 501 comprising content reception, distribution, and switching portion 604, head-end transport portion 605, and hot key generation system 615.

Content reception, distribution, and switching portion 604 is connected with one or more of satellite receiver 601, over the air broadcast receiver 602, fiber optical feed 603, and other types of links (not shown) to receive signals from one or more content providers. Content reception, distribution, and switching portion 604 comprises equipment that that is commonly used to receive broadcast signals, demodulate the broadcast signals to separate the content signals from a carrier signal if necessary, distribute and arrange the content from the content providers to fit a programming schedule of the service provider, and provide switching of these signals between the various components of the head-end and data center 501.

Head-end transport portion 605 comprises a plurality of encoders 606-612, optional back-up encoder 613, multiplexor system 614, modulation system 618, up converters 619, and transport system 621. Encoders 605-612 and optional back-up encoder 613 receive interactive TV content signals from content reception, distribution, and switching portion 604 and encode the content signals into any of a variety of well known formats such as Motion Pictures Experts Group Standard 2 (MPEG-2), Motion Pictures Experts Group Standard 4 (MPEG-4), DivX, or any other format. Encoders 605-612 and optional back-up encoder 613 each provide an individual encoded data stream representing the content signal of a single channel to multiplexor system 614.

Hot key generation system 615 is also connected with multiplexor system 614 of head-end transport 605. Hot key generation system 615 receives content 623 from content reception, distribution, and switching portion 604, trigger programming information 616, and event data feed 617. Trigger programming information 616 provides an indication of the time, date, etc. that given content will be played out. Event data feed 617 provides live content rather than content that is programmed and played out at a scheduled time. Using content 623, trigger programming information 616, and event data feed 617 hot key generation system 615 generates hot key signals associated with content to be broadcast from head-end and data center 501 and outputs the hot key signals to multiplexor system 614. An exemplary process for generating hot key signals as may be performed by hot key generation system 615 will be discussed below with reference to FIG. 7.

Multiplexor system 614 may comprise a primary as well as an optional back-up multiplexor. Multiplexor system 614 combines the encoded content signals from encoders 605-612 and optional back-up encoder 613 and hot key signals from hot key generation system 615 to provide an output data stream. The output stream of multiplexor system 614 comprises the individual encoded data streams representing the content signals of the individual channels as well as any associated hot key signals.

The output stream of multiplexor system 614 may be applied to a modulation system 618. Modulation system 618 may comprise a primary as well as an optional back-up modulator. Modulation system 618 uses the output data stream of multiplexor system 614 to modulate a carrier frequency for transmission from the head-end system 501.

Modulation system 618 supplies the modulated carrier signal to up converters 619. Up converters 619 may comprise primary as well as optional back-up converters. Additionally, up converters 619 may comprise multiple stages of converters. The function of up converters 619 is to increase the modulated carrier frequency to a range that is suitable for broadcast. Up converters 619 then transmit the modulated carrier signal from head-end and data center 501 via network 620 to users.

Optionally, or in addition to modulation system 618, the output of multiplexor system 614 may be applied to transport system 621 that may comprise a primary as well as an optional back-up transport system. The function of the transport system 621 is to prepare the output stream of multiplexor system 614 for transmission over network 622. That is, transport system 621 places the output stream of multiplexor system 614 into a format and protocol appropriate for network 622. For example, the output stream of multiplexor system may be placed into Internet Protocol (IP) packets or placed into an Asynchronous Transfer Mode (ATM) channel by transport system 621.

FIG. 7 is a flowchart illustrating head-end and data center processing for adding hot key signals to a broadcast signal according to one embodiment of the present invention. This process may be performed by a system such as the hot key generation system of the head-end and data center described above with reference to FIG. 6 or any other system with similar capabilities.

First, at decision block 700, the system determines whether a hot key signal should be added to the current content. This determination may be made by a local television operator such as a decision to provide a hot key on a local advertisement that gives the user the opportunity to find out more about a local product. Alternatively, this determination may be made by an original national content provider such as a national network to provide a hot key to all users or to users living in a certain state or region.

If a hot key signal is to be added to the current content, the hot key signal may be generated at processing block 705. According to one embodiment of the present invention, the hot key signal may comprise a special purpose Internet Protocol (IP) packet as described below with reference to FIG. 8. Alternatively, the hot key signal may be any other type of digital signal or packet suitable for transmission over the type of network being used and capable of carrying information similar to that shown in FIG. 8.

Finally, at processing block 705, the hot key signal is inserted into the content signal. That is, the hot key IP packet or other signal is multiplexed with the content data stream as described above with reference to FIG. 6.

According to one embodiment of the present invention, alternate content may be pre-loaded or cached on the users equipment prior to transmission of the hot key signal. That is, the head-end and data center may first send available alternate content to the user's equipment such as an STB or gateway. The user's equipment may cache the alternate content on a hard drive or other large capacity storage device. Once the alternate content is cached, a hot key informs the user of the availability of the content. The user may then view the content, reject the content, choice to view the content at a later time, or other possible options.

FIG. 8 is a diagram illustrating one possible format for a hot key data packet according to one embodiment of the present invention. This example illustrates an IP data packet 800. The IP data packet includes a header 801 and a body 802.

Header 801 includes a number of fields 803-811 that are typically found in IP data packets. These fields include a source port 803, a destination port 804, a sequence number 805, an acknowledgement number 806, a data offset 807, a reserved field 808, a window field 809, checksum data 810, and an urgent pointer 811. It should be noted that such an IP data packet may be sent to multiple address using IP multicasting. Multicasting therefore allows efficient broadcasting of the hot key signals from the head-end and data center to users.

Body 802 may also include a number of fields 812-815. These fields may include a hot key type 812, a content type 813, a content location 814, and a message field 815. In various applications, the number of fields used, size of the fields, type of data presented, format of the data, content of the fields, etc. may vary. For example, in some cases not all of the fields presented here may be used. In other cases, additional data may be presented such as additional graphical or textual information. Additionally, the data may be presented in a wide variety of formats such as plain American Standard Code for Information Interchange (ASCII) text, other binary representations or even encrypted.

Regardless of format, hot key type field 812 may represent the type of hot key signal being used. For example, the hot key signal represented by IP data packet 800 may indicate that alternate content is available on another channel or on a web site. Alternatively, the hot key signal may indicate that alternate content is available to be cached on the user's terminal device.

Content type field 813 may represent the type, genre, or other details about the alternate content. For example, this field 813 may be used to indicate that the alternate content is a sporting event or movie. Of course, additional details may also be included. For example, the field 813 may indicate that the alternate content is an action movie and name the actors and director. This information may be used by the user's terminal device to judge the relevance of the hot key signal to the user as will be discussed below.

Content location field 814 may indicate where the alternate content is located. For example, this field 814 may indicate another channel, a web site URL or indicate that the content has been cached on the user's terminal device.

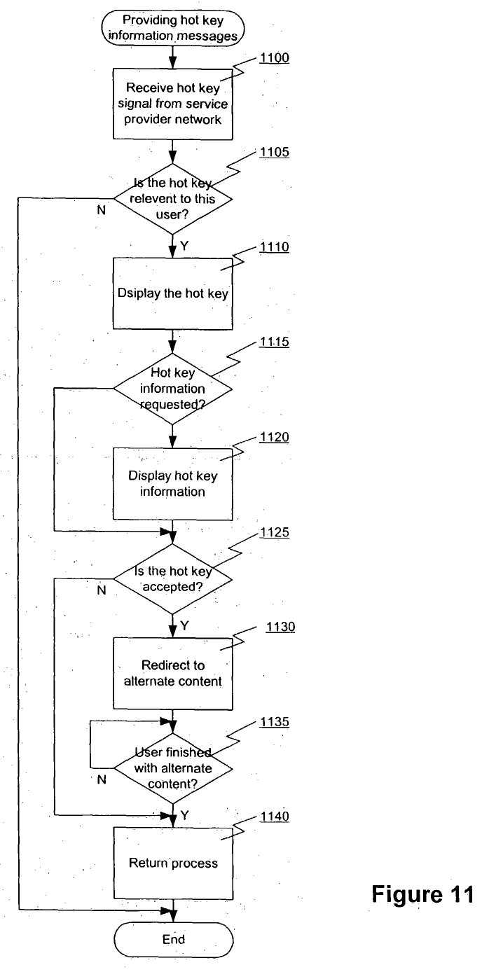

Message field 815 may include additional textual or graphical information regarding the hot key or the alternate content. For example, the message field 815 may contain a text message to be displayed to the user providing details of the alternate content as will be discussed below with reference to FIG. 11. This message may be presented to the user automatically or at his option to help the user decide whether to accept or decline the hot key.

FIG. 9 is a block diagram illustrating a user side system to redirect a user to alternate content responsive to selection of an embedded hot key according to one embodiment of the present invention. As discussed above, the user side system may vary significantly. The user side system comprising a terminal device, STB, Gateway or similar device, performs functions such as exchanging messages (including video-related data) over a network with head-end and data center, receiving messages from a user input device, such as a hand-held remote control unit, translating video signals from a network-native format into a format that can be used by televisions or other display devices, providing a video signal to televisions or other display devices, and other functions.

The functionality of the user side system may reside in a stand-alone device, literally a box that can be placed on, or at least near, the television, that is similar in outward form to conventional devices for receiving cable programs. The user side system functionality could alternatively be performed by hardware resident elsewhere, such as within the television or display console, or by any suitably equipped terminal device. Since the hardware may be proprietary to the service provider and may generally be a physically independent device, the term set top box is used here, but any type of terminal device with similar functionality may be used.

In the example illustrated in FIG. 9, the user side system comprises an STB 508. STB 508 comprises tuner, receiver, demodulator 901, demultiplexor 902, decoder 903, graphics processor 904, central processing unit (CPU) 905, optional hard disk drive 906 or other mass storage device, memory 907, and various possible inputs and outputs 908.

Tuner, receiver, demodulator 901 receives signals from the service provider network 504 over any of a variety of media as discussed above. Specifically, tuner, receiver, demodulator 901 receives signals of a frequency band to which it is tuned and demodulates the signals to remove content signals from a carrier signal if any. Demodulated content signals are then supplied by tuner, receiver, demodulator 901 to demultiplexor 902.

Demultiplexor 902 receives the demodulated content signals from tuner, receiver, demodulator 901 and separates the content into multiple data streams representing various channels. The multiple data streams are then supplied as an input to decoder 903.

Decoder 903 receives the multiple data streams from demultiplexor 902 and decodes or decompresses the data streams using an appropriate algorithm. For example, if the head-end and data center compressed the video signals into an MPEG-2 data stream, decoder 903 will decode the MPEG-2 data stream from demultiplexor 902 to form a standard video signal. The video signal from decoder 903 is then supplied to graphics processor 904.

Graphics processor 904 receives the decoded video signals from decoder 903 and processes the video signals to reduce noise, provide amplifications, etc. Processed video signals from graphics processor 904 are supplied to input/output module 908. Input/output module 908 may provide a variety of possible output types. For example, outputs may include but are not limited to Audio/Video (A/V), Radio Frequency (RF), Sony/Phillips Digital Interface (SPDIF), Universal Serial Bus (USB), and others.

Input/output module 908 also receives control signals from the user. These control signals are typically InfraRed (IR) or Radio Frequency (RF) signals from a remote control unit. Control signals from the user are then fed back from input/output module 908 to Central Processing Unit (CPU) 905.

CPU 905 executes instruction stored in memory 907. Memory 907 may comprise A Random Access Memory (RAM) such as flash memory, or other non-volatile memory. The instructions stored in memory 907, when executed by CPU 905 cause CPU 905 to perform various functions such as controlling the various elements of STB 508, receiving hot key signals, switching to alternate content, and responsive to selection of an embedded hot key, controlling picture-in-picture presentation of content, presenting a set of user options for handling hot key signals, presenting user options for returning from alternate content, presenting information messages for hot keys, and presenting descriptive hot key forms as will be described below with reference to FIGS. 10 through 14.

Generally, a hot key signal will be received at tuner, receiver, and demodulator 901 along with and embedded in content signals from the head-end and data center and transmitted over service provider network 504. CPU 905 monitors the demultiplexed data streams from demultiplexor 902 for the presence of relevant hot key signals.

STB 508 may also contain an optional hard disk drive 906 or other mass storage device. Hard disk drive 906 allows STB 508 to cache alternate content for later viewing by the user. If CPU 905 detects a hot key signal instructing content to be cached, the demultiplexed data stream from demultiplexor 902 may be saved on hard disk drive 906. The still compressed content is stored on hard disk drive 906 until the user chooses to view it. Once the user chooses to view the cached content, CPU 905 may retrieve the content from hard disk drive 906 and provide the compressed data stream to be decoded by decoder 903, processed by graphics processor 904, and output through input/output module 908.

FIG. 10 is a flowchart illustrating processing on a user side system for presenting alternate content in a picture-in-picture mode according to one embodiment of the present invention. This process may be performed by a system such as described above with reference to FIG. 9 or any other system with similar capabilities.

First, at processing block 1000, the system receives a hot key signal from the service provider's network. As discussed above, the hot key signal may be in the form of a specialized IP packet or another type of signal embedded in the content signal from the service provider.

At decision block 1005 a determination is made as to whether the hot key signal is relevant to the particular user. Since numerous hot key signals may be broadcast at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content types or genres which have been selected by the user. Regardless of the algorithm or criteria used to judge relevance, if the hot key signal is determined at decision block 1005 to not be relevant, no further processing is performed.

If the hot key signal is determined at decision block 1005 to be relevant to the user, a hot key icon or other indication is displayed to the user at processing block 1010. As mentioned above, this indication may be in the form of an icon placed on the screen, a text message, a tone or even a verbal alert. Regardless of the exact form, some indication is given to the user that a hot key has been received.

At decision block 1015 a determination is made as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 1015 that the user did not accept the hot key, no further processing is performed.

If, at decision block 1015, the user accepts the hot key, a determination is made at processing block 1020 as to which content will be displayed in the PIP. That is, a determination is made as to whether to display the alternate or the original content in the PIP. As discussed above, exactly how the alternate content is displayed may be determined at the users terminal device. The terminal device may default to one method, may be configured by the user to perform another method, may query the user to determine his preference prior to displaying the alternate content, or may use another method to determine which content to display in which portion of the display. Depending on this determination, a PIP is opened and the alternate content is displayed at processing block 1025.

At decision block 1030 a determination is made as to whether the user has finished consuming the alternate content. This determination may be based on any of a variety of possible criteria. For example, the user may press a button or series of buttons on a remote control to indicate that he has finished viewing the presented material. Alternatively, the user may use a mouse or other pointing device of a remote control to select a graphic on the display to indicate that he has finished viewing the presented material.

Once a determination is made at decision block 1030 that the user is finished with the alternate content, a return process is entered at processing block 1035. This return process may include simply returning the user to the previous content. Alternatively, the return process may comprise presenting to the user other available content based on other hot key signals. Another alternative may include presenting a user with a number of choices of how to proceed.

FIG. 11 is a flowchart illustrating processing on a user side system for providing hot key information messages according to one embodiment of the present invention. This process may be performed by a system such as described above with reference to FIG. 9 or any other system with similar capabilities.

First, at processing block 1100, the system receives a hot key signal from the service provider's network. As discussed above, the hot key signal may be in the form of a specialized IP packet or another type of signal embedded in the content signal from the service provider.

At decision block 1105 a determination is made as to whether the hot key signal is relevant to the particular user. Since numerous hot key signals may be broadcast at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content type or genres which have been selected by the user. Regardless of the algorithm or criteria used to judge relevance, if the hot key signal is determined at decision block 1105 to not be relevant, no further processing is performed.

If the hot key signal is determined at decision block 1105 to be relevant to the user, a hot key icon or other indication is displayed to the user at processing block 1110. As mentioned above, this indication may be in the form of an icon placed on the screen, a text message, a tone or even a verbal alert. Regardless of the exact form, some indication is given to the user that a hot key has been received.

At decision block 1115 a determination is made as to whether hot key information is requested. Hot key information may be requested by the user pressing a button on the remote control or performing some other operation once a hot key icon or other indication has been given. Alternatively, the determination may default to always presenting hot key information.

If, at decision block 1115, hot key information is requested, hot key information is displayed at processing block 1120. That is, the text or other information, describing the hot key is read from the hot key signal and presented to the user. For example, a text message describing the alternate content may be included in the body of an IP packet representing a hot key signal as described above. This text may be read from the hot key signal and displayed on the users screen to inform him of the nature of the alternate content.

At decision block 1125 a determination is made as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 1125 the user did not accept the hot key, no further processing is performed.

If, at decision block 1125, the user accepts the hot key, the user is redirected to the alternate content at processing block 1130. That is, the user's terminal device changes channels or sources to the content indicated by the hot key signal.

At decision block 1135 a determination is made as to whether the user has finished consuming the alternate content. This determination may be based on any of a variety of possible criteria. For example, the user may press a button or series of buttons on a remote control to indicate that he has finished viewing the presented material. Alternatively, the user may use a mouse or other pointing device of a remote control to select a graphic on the display to indicate that he has finished viewing the presented material.

Once a determination is made at decision block 1135 that the user is finished with the alternate content, a return process is entered at processing block 1140. This return process may include simply returning the user to the previous content. Alternatively, the return process may comprise presenting to the user other available content based on other hot key signals. Another alternative may include presenting a user with a number of choices of how to proceed.

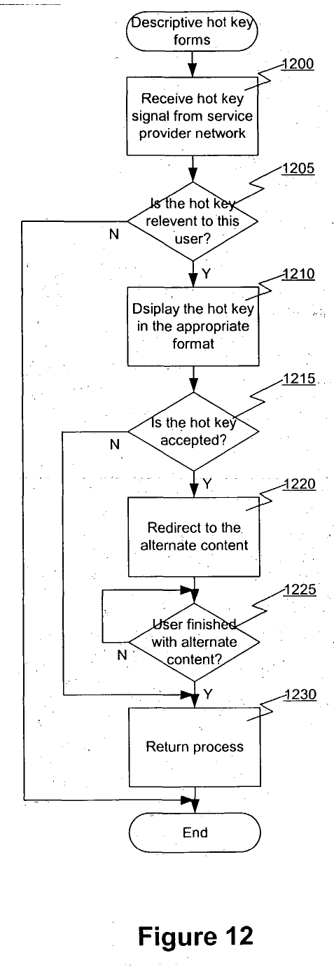

FIG. 12 is a flowchart illustrating processing on a user side system for providing descriptive hot key forms according to one embodiment of the present invention. This process may be performed by a system such as described above with reference to FIG. 9 or any other system with similar capabilities.

First, at processing block 1200, the system receives a hot key signal from the service provider's network. As discussed above, the hot key signal may be in the form of a specialized IP packet or another type of signal embedded in the content signal from the service provider.

At decision block 1205 a determination is made as to whether the hot key signal is relevant to the particular user. Since numerous hot key signals may be broadcast at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content type or genres which have been selected by the user. Regardless of the algorithm or criteria used to judge relevance, if the hot key signal is determined at decision block 1205 to not be relevant, no further processing is performed.

If the hot key signal is determined at decision block 1205 to be relevant to the user, a hot key icon or other indication is displayed in an appropriate format at processing block 1210. As mentioned above, this indication may be in the form of an icon placed on the screen, a text message, a tone or even a verbal alert. Additionally, the format of the indication may vary with the format of the hot key signal. According to one embodiment of the present invention, the hot key signal, such as the IP data packet discussed above with reference to FIG. 8, may include data indicating the type of alternate content available. For example, the hot key signal may indicate that the alternate content is a sporting event or more specifically, an NFL game between the Atlanta Falcons and the Denver Broncos. In such a case, the user's terminal device may display an icon resembling a football or even a team logo.

According to one embodiment of the present invention, the various icons related to possible types of alternate content may be preset in the user's terminal device. For example, there may be a default set of icons stored in memory. Alternatively, the user may be able to customize the icons used through a setup routine of his terminal device. During this setup routine, he may be able to select a set of icons from a larger standard set or even download various icons from the service provider. According to yet another alternative, the icons or other custom formats may be delivered in the hot key signal. For example, a graphic such as an icon may be delivered to the user in one or more hot key signals comprising IP packets such as the one discussed above with reference to FIG. 8.

Once the hot key has been displayed in the appropriate format, a determination is made at decision block 1215 as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 1215 the user did not accept the hot key, no further processing is performed.

If, at decision block 1215, the user accepts the hot key, the user is redirected to the alternate content at processing block 1220.

At decision block 1225 a determination is made as to whether the user has finished consuming the alternate content. This determination may be based on any of a variety of possible criteria. For example, the user may press a button or series of buttons on a remote control to indicate that he has finished viewing the presented material. Alternatively, the user may use a mouse or other pointing device of a remote control to select a graphic on the display to indicate that he has finished viewing the presented material.

Once a determination is made at decision block 1225 that the user is finished with the alternate content, a return process is entered at processing block 1230. This return process may include simply returning the user to the previous content. Alternatively, the return process may comprise presenting to the user other available content based on other hot key signals. Another alternative may include presenting a user with a number of choices of how to proceed.

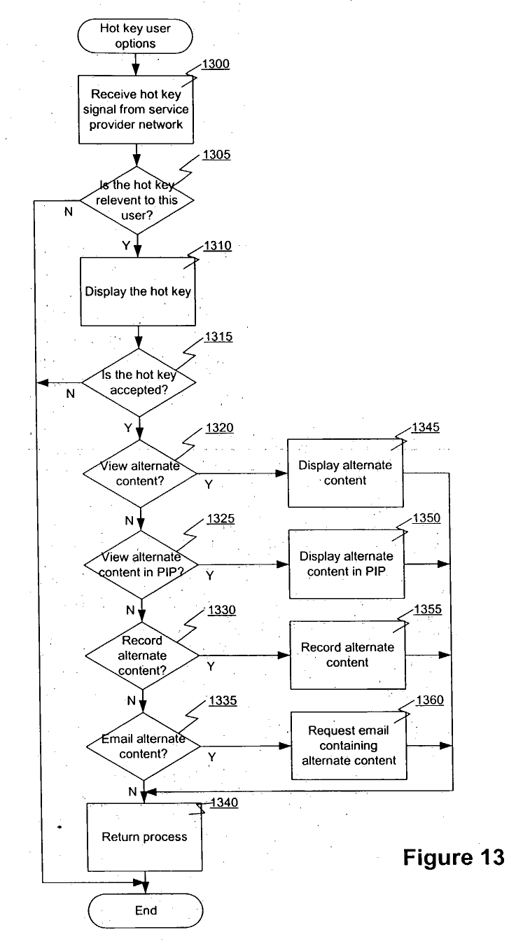

FIG. 13 is a flowchart illustrating processing on a user side system for providing hot key user options capability according to one embodiment of the present invention. This process may be performed by a system such as described above with reference to FIG. 9 or any other system with similar capabilities.

First, at processing block 1300, the system receives a hot key signal from the service provider's network. As discussed above, the hot key signal may be in the form of a specialized IP packet or another type of signal embedded in the content signal from the service provider.

At decision block 1305 a determination is made as to whether the hot key signal is relevant to the particular user. Since numerous hot key signals may be broadcast at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content type or genres which have been selected by the user. Regardless of the algorithm or criteria used to judge relevance, if the hot key signal is determined at decision block 1305 to not be relevant, no further processing is performed.

If the hot key signal is determined at decision block 1305 to be relevant to the user, a hot key icon or other indication is displayed to the user at processing block 1310. As mentioned above, this indication may be in the form of an icon placed on the screen, a text message, a tone or even a verbal alert. Regardless of the exact form, some indication is given to the user that a hot key has been received.

At decision block 1315 a determination is made as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 1315 the user did not accept the hot key, no further processing is performed.

If, at decision block 1315, the user accepts the hot key, a menu of choices is presented represented by the series of decision blocks 1320 through 1335. As discussed above, the options presented by this menu may vary. However, this example illustrates menu options for viewing the alternate content, viewing the alternate content in a PIP, recording the alternate content, and requesting that the alternate content be delivered to an email address.

If, at decision block 1320, the option to view the alternate content is selected, the alternate content will be displayed at processing block 1345.

If, at decision block 1325, the option to view the alternate content in a PIP is selected, a PIP is opened and the alternate content is displayed. As discussed above, the alternate content may be displayed on the main portion of the display and the original content may be displayed in the PIP. Alternatively, the original content may be displayed in the main portion of the display and alternate content may be displayed in the PIP. Exactly how the alternate content is displayed may be determined at the users terminal device. The terminal device may default to one method, may be configured by the user to perform another method, may query the user to determine his preference prior to displaying the alternate content, or may use another method to determine which content to display in which portion of the display.

If, at decision block 1330, the option to record the alternate content is selected, the alternate content will be record by the user's terminal device while the user continues to view the original content. That is, the alternate content will be stored in a hard disk drive or other large capacity storage device internal or external to the terminal device to be available for the user at a later time.

If, at decision block 1335, the option to request that the alternate content be sent to an email address is selected, the user's terminal device will send a request back to the head-end and data center indicating an email address to which the alternate content should be sent. The email address may by default be that of the user. Alternatively, the user may be able to enter, via a keyboard, remote control, or pointing device, another email address to which the alternate content should be sent.

Once the user is finished with the alternate content or has exited the menu, a return process is entered at processing block 1340. This return process may include simply returning the user to the previous content. Alternatively, the return process may comprise presenting to the user other available content based on other hot key signals. Another alternative may include presenting a user with a number of choices of how to proceed.

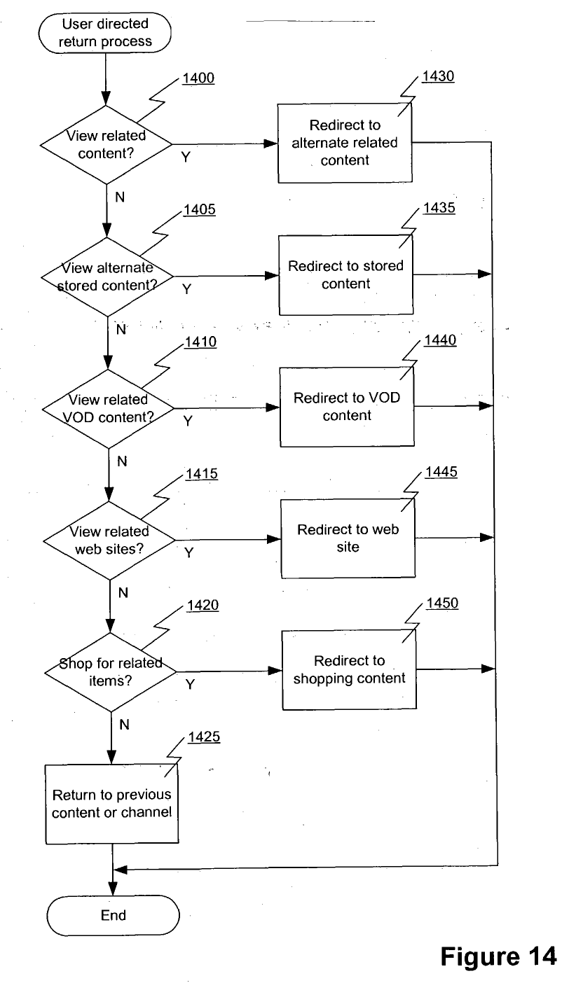

FIG. 14 is a flowchart illustrating processing on a user side system for providing user directed return capability according to one embodiment of the present invention. This process may be performed by a system such as described above with reference to FIG. 9 or any other system with similar capabilities. According to one embodiment of the present invention, this return process may be initiated after a user has finished viewing alternate content. Alternatively, the return process may be initiated by the user at any time during the alternate content by pushing one or more buttons on the remote control, using a mouse or other pointing device, etc. At that time, the user may be presented with a menu of return options.

Decision blocks 1400 through 1425 represent a plurality of return options presented by the return menu. As discussed above, these options may vary widely. However, this example illustrates options for viewing related content, viewing alternate stored content, viewing related Video On Demand (VOD) content, viewing related web sites, and shopping for related items.

If, at decision block 1400, the option to view related content is selected, the user is redirected to related alternate content at processing block 1430. This alternate content may be indicated by hot key signals received while the user was viewing the original or alternate content.

If, at decision block 1405, the option to view alternate stored content is selected, the user will be redirected to previously stored content at processing block 1435. The stored content may have been stored by the user's terminal device while the user was viewing the original or the alternate content or at an earlier time.

If, at decision block 1410, the option to view related VOD content is selected, the user will be redirected to the VOD content at processing block 1440. The VOD content may include pay-per-view content such as a movie, sporting event, or other content.

If, at decision block 1415, the option to view related web sites is selected, the user will be redirected to a web site at processing block 1445. This process may be available if the user's terminal device includes a web browser and has access to the Internet via either the service provider's network or another connection. Additionally, the hot key signal indicating the availability of alternate content on a web site may include an indication of the URL of the content. For example, the IP packet discussed above with reference to FIG. 8 may include a data field in the body of the packet indicating a URL for alternate content.

If, at decision block 1420, the option to shop for related items is selected, the user will be redirected to shopping content at processing block 1450. This shopping content may be in the form of commercial video content such as an “infomercial”, a commercial web site, or other commercial information.

If the user exits the menu without choosing one of the presented options, the process may, by default, return to the previously viewed original content. If the original content has since played out or ended, the user may be returned to the channel in which the original content was present.

What is claimed is:

1. A method comprising:
receiving a hot key signal from an interactive television service provider's network, the hot key signal indicating availability and a location of alternate content;
determining whether the hot key signal is relevant to a user viewing original content from the interactive television service provider;
responsive to determining the hot key signal is relevant to the user, displaying on a screen an indication that the hot key signal has been received; and
responsive to receiving an indication that the hot key is accepted, determining a location on a screen for the alternate content and displaying the original content and the alternate content in a Picture-In-Picture mode.

2. The method of claim 1, wherein the hot key signal comprises an Internet Protocol (IP) data packet, the IP data packet having a header portion and a body portion, the body portion having a data field indicating the location of the alternate content.

3. The method of claim 1, wherein determining whether the hot key signal is relevant to the user comprises determining whether a destination address for the hot key signal is an address of the user.

4. The method of claim 3, wherein determining whether the hot key signal is relevant to the user further comprises determining whether the alternate content is related to content currently being viewed by the user.

5. The method of claim 1, wherein determining a location on the screen for the alternate content comprises determining whether the alternate content will be presented in a main portion of the screen or in a PIP frame.

6. The method of claim 5, wherein determining a location on the screen for the alternate content is based on a default location.

7. The method of claim 5, wherein determining a location on the screen for the alternate content is based on a pre-selected location set by the user.

8. The method of claim 5, wherein determining a location on the screen for the alternate content is based on a selection by the user at the time the hot key is accepted.

9. A method comprising:
receiving a hot key signal from an interactive television service provider's network, the hot key signal indicating availability and a location of alternate content and containing information providing details regarding the alternate content;
determining whether the hot key signal is relevant to a user viewing original content from the interactive television service provider; and
responsive to determining the hot key signal is relevant to the user, displaying on a screen an indication that the hot key signal has been received.

10. The method of claim 9, further comprising displaying to the user the information providing details regarding the alternate content.

11. The method of claim 9, further comprising responsive to the user requesting additional information, displaying to the user the information providing details regarding the alternate content.

12. The method of claim 9, further comprising responsive to receiving an indication that the hot key is accepted, displaying the alternate content to the user.

13. The method of claim 9, wherein the hot key signal comprises an Internet Protocol (IP) data packet, the IP data packet having a header portion and a body portion, the body portion having a data field indicating the location of the alternate content.

14. A method comprising:
receiving a hot key signal from an interactive television service provider's network, the hot key signal indicating availability and a location of alternate content and containing data representing a hot key form;
determining whether the hot key signal is relevant to a user viewing original content from the interactive television service provider; and
responsive to determining the hot key signal is relevant to the user, displaying on a screen an indication that the hot key signal has been received, the indication corresponding to the data representing the hot key form.

15. The method of claim 14, wherein the data representing the hot key form indicates one of a plurality of possible hot key forms.

16. The method of claim 14, wherein the data representing the hot key form comprises a graphic.

17. The method of claim 16, wherein the graphic is displayed on the screen as the indication that the hot key signal has been received.

18. The method of claim 17, wherein the graphic is pre-selected by the user.

19. The method of claim 17, wherein the graphic is included in the hot key signal.

20. A method comprising:
receiving a hot key signal from an interactive television service provider's network, the hot key signal indicating availability and a location of alternate content;
determining whether the hot key signal is relevant to a user viewing original content from the interactive television service provider;
responsive to determining the hot key signal is relevant to the user, displaying on a screen an indication that the hot key signal has been received; and
responsive to receiving an indication that the hot key is accepted, displaying on the screen a menu of options for handling the alternate content.

21. The method of claim 20, wherein the menu of options includes an option to view the alternate content.

22. The method of claim 20, wherein the menu of options includes an option to view the alternate content in a Picture-In-Picture (PIP) mode.

23. The method of claim 20, wherein the menu of options includes an option to record the alternate content.

24. The method of claim 20, wherein the menu of options includes an option to request an email containing the alternate content.

25. A method comprising:
receiving a hot key signal from an interactive television service provider's network, the hot key signal indicating availability and a location of alternate content;
determining whether the hot key signal is relevant to a user viewing original content from the interactive television service provider;
responsive to determining the hot key signal is relevant to the user, displaying on a screen an indication that the hot key signal has been received;
responsive to receiving an indication that the hot key is accepted, presenting the alternate content to the user; and
responsive to the user finishing the alternate content, displaying on the screen a menu of options for returning from the alternate content.

26. The method of claim 25, wherein the menu of options includes an option to view content related to the alternate content.

27. The method of claim 25, wherein the menu of options includes an option to view content previously cached on a terminal device.

28. The method of claim 25, wherein the menu of options includes an option to view Video-On-Demand (VOD) content related to the alternate content.

29. The method of claim 25, wherein the menu of options includes an option to view web sites related to the alternate content.

30. The method of claim 25, wherein the menu of options includes an option to shop for items related to the alternate content.

31. The method of claim 25, wherein the menu of options includes an option to return to a previous channel.

32. A system comprising:
a tuner, receiver, and demodulator portion and a demultiplexor portion to receive a hot key signal indicating availability and a location of alternate content; and
a processor to determine whether the hot key signal is relevant to a user viewing original content from the interactive television service provider, responsive to determining the hot key signal is relevant to the user, display on a screen an indication that the hot key signal has been received, and responsive to receiving an indication that the hot key is accepted, determine a location on a screen for the alternate content and displaying the original content and the alternate content in a Picture-In-Picture mode.

33. The system of claim 32, wherein the hot key signal comprises an Internet Protocol (IP) data packet, the IP data packet having a header portion and a body portion, the body portion having a data field indicating the location of the alternate content.

34. The system of claim 32, wherein the processor determines whether the hot key signal is relevant to the user based on whether a destination address for the hot key signal is an address of the user.

35. The system of claim 34, wherein the processor determines whether the hot key signal is relevant to the user based on whether the alternate content is related to content currently being viewed by the user.

36. The system of claim 32, wherein the processor determines a location on the screen for the alternate content based on whether the alternate content will be presented in a main portion of the screen or in a PIP frame.

37. The system of claim 36, wherein the processor determines a location on the screen for the alternate content based on a default location.

38. The system of claim 36, wherein the processor determines a location on the screen for the alternate content based on a pre-selected location set by the user.

39. The system of claim 36, wherein the processor determines a location on the screen for the alternate content based on a selection by the user at the time the hot key is accepted.

40. A system comprising:
a tuner, receiver, and demodulator portion and a demultiplexor portion to receive a hot key signal from an interactive television service provider's network, the hot key signal indicating availability and a location of alternate content and containing information providing details regarding the alternate content;
a processor to determine whether the hot key signal is relevant to a user viewing original content from the interactive television service provider, and responsive to determining the hot key signal is relevant to the user, display on a screen an indication that the hot key signal has been received.

41. The system of claim 40, wherein the processor displays to the user the information providing details regarding the alternate content.

42. The system of claim 40, wherein the processor, responsive to the user requesting additional information, displays to the user the information providing details regarding the alternate content.

43. The system of claim 40, wherein the processor, responsive to receiving an indication that the hot key is accepted, displays the alternate content to the user.

44. The system of claim 40, wherein the hot key signal comprises an Internet Protocol (IP) data packet, the IP data packet having a header portion and a body portion, the body portion having a data field indicating the location of the alternate content.

45. A system comprising:
a tuner, receiver, and demodulator portion and a demultiplexor portion to receive a hot key signal from an interactive television service provider's network, the hot key signal indicating availability and a location of alternate content and containing data representing a hot key form; and
a processor to determine whether the hot key signal is relevant to a user viewing original content from the interactive television service provider, and responsive to determining the hot key signal is relevant to the user, displaying on a screen an indication that the hot key signal has been received, the indication corresponding to the data representing the hot key form.

46. The system of claim 45, wherein the data representing the hot key form indicates one of a plurality of possible hot key forms.

47. The system of claim 45, wherein the data representing the hot key form comprises a graphic.

48. The system of claim 47, wherein the graphic is displayed on the screen as the indication that the hot key signal has been received.

49. The system of claim 48, wherein the graphic is pre-selected by the user.

50. The system of claim 48, wherein the graphic is included in the hot key signal.

51. A system comprising:
a tuner, receiver, and demodulator portion and a demultiplexor portion to receive a hot key signal from an interactive television service provider's network, the hot key signal indicating availability and a location of alternate content; and
a processor to determine whether the hot key signal is relevant to a user viewing original content from the interactive television service provider, responsive to determining the hot key signal is relevant to the user, displaying on a screen an indication that the hot key signal has been received, and responsive to receiving an indication that the hot key is accepted, displaying on the screen a menu of options for handling the alternate content.

52. The system of claim 51, wherein the menu of options includes an option to view the alternate content.

53. The system of claim 51, wherein the menu of options includes an option to view the alternate content in a Picture-In-Picture (PIP) mode.

54. The system of claim 51, wherein the menu of options includes an option to record the alternate content.

55. The system of claim 51, wherein the menu of options includes an option to request an email containing the alternate content.

56. A system comprising:
a tuner, receiver, and demodulator portion and a demultiplexor portion to receive a hot key signal from an interactive television service provider's network, the hot key signal indicating availability and a location of alternate content; and
a processor to determine whether the hot key signal is relevant to a user viewing original content from the interactive television service provider, responsive to determining the hot key signal is relevant to the user, displaying on a screen an indication that the hot key signal has been received, responsive to receiving an indication that the hot key is accepted, presenting the alternate content to the user, and responsive to the user finishing the alternate content, displaying on the screen a menu of options for returning from the alternate content.

57. The system of claim 56, wherein the menu of options includes an option to view content related to the alternate content.

58. The system of claim 56, wherein the menu of options includes an option to view content previously cached on a terminal device.

59. The system of claim 56, wherein the menu of options includes an option to view Video-On-Demand (VOD) content related to the alternate content.

60. The system of claim 56, wherein the menu of options includes an option to view web sites related to the alternate content.

61. The system of claim 56, wherein the menu of options includes an option to shop for items related to the alternate content.

62. The system of claim 56, wherein the menu of options includes an option to return to a previous channel.

63. A machine-readable medium having stored thereon a series of instructions, the instructions, when executed by a processor, cause the processor to:
receive a hot key signal from an interactive television service provider's network, the hot key signal indicating availability and a location of alternate content;
determine whether the hot key signal is relevant to a user viewing original content from the interactive television service provider;
responsive to determining the hot key signal is relevant to the user, display on a screen an indication that the hot key signal has been received; and
responsive to receiving an indication that the hot key is accepted, determine a location on a screen for the alternate content and displaying the original content and the alternate content in a Picture-In-Picture mode.

64. The machine-readable medium of claim 63, wherein the hot key signal comprises an Internet Protocol (IP) data packet, the IP data packet having a header portion and a body portion, the body portion having a data field indicating the location of the alternate content.

65. The machine-readable medium of claim 63, wherein determining whether the hot key signal is relevant to the user comprises determining whether a destination address for the hot key signal is an address of the user.

66. The machine-readable medium of claim 65, wherein determining whether the hot key signal is relevant to the user further comprises determining whether the alternate content is related to content currently being viewed by the user.

67. The machine-readable medium of claim 63, wherein determining a location on the screen for the alternate content comprises determining whether the alternate content will be presented in a main portion of the screen or in a PIP frame.

68. The machine-readable medium of claim 67, wherein determining a location on the screen for the alternate content is based on a default location.

69. The machine-readable medium of claim 67, wherein determining a location on the screen for the alternate content is based on a pre-selected location set by the user.

70. The machine-readable medium of claim 67, wherein determining a location on the screen for the alternate content is based on a selection by the user at the time the hot key is accepted.

71. A machine-readable medium having stored thereon a series of instructions, the instructions, when executed by a processor, cause the processor to:
receive a hot key signal from an interactive television service provider's network, the hot key signal indicating availability and a location of alternate content and containing information providing details regarding the alternate content;
determine whether the hot key signal is relevant to a user viewing original content from the interactive television service provider; and
responsive to determining the hot key signal is relevant to the user, display on a screen an indication that the hot key signal has been received.

72. The machine-readable medium of claim 71, further comprising displaying to the user the information providing details regarding the alternate content.

73. The machine-readable medium of claim 71, further comprising responsive to the user requesting additional information, displaying to the user the information providing details regarding the alternate content.

74. The machine-readable medium of claim 71, further comprising responsive to receiving an indication that the hot key is accepted, displaying the alternate content to the user.

75. The machine-readable medium of claim 71, wherein the hot key signal comprises an Internet Protocol (IP) data packet, the IP data packet having a header portion and a body portion, the body portion having a data field indicating the location of the alternate content.

76. A machine-readable medium having stored thereon a series of instructions, the instructions, when executed by a processor, cause the processor to:
receive a hot key signal from an interactive television service provider's network, the hot key signal indicating availability and a location of alternate content and containing data representing a hot key form;
determine whether the hot key signal is relevant to a user viewing original content from the interactive television service provider; and
responsive to determining the hot key signal is relevant to the user, display on a screen an indication that the hot key signal has been received, and the indication corresponding to the data representing the hot key form.

77. The machine-readable medium of claim 76, wherein the data representing the hot key form indicates one of a plurality of possible hot key forms.

78. The machine-readable medium of claim 76, wherein the data representing the hot key form comprises a graphic.

79. The machine-readable medium of claim 78, wherein the graphic is displayed on the screen as the indication that the hot key signal has been received.

80. The machine-readable medium of claim 79, wherein the graphic is pre-selected by the user.

81. The machine-readable medium of claim 79, wherein the graphic is included in the hot key signal.

82. A machine-readable medium having stored thereon a series of instructions, the instructions, when executed by a processor, cause the processor to:
receive a hot key signal from an interactive television service provider's network, the hot key signal indicating availability and a location of alternate content;
determine whether the hot key signal is relevant to a user viewing original content from the interactive television service provider;
responsive to determining the hot key signal is relevant to the user, display on a screen an indication that the hot key signal has been received; and
responsive to receiving an indication that the hot key is accepted, display on the screen a menu of options for handling the alternate content.

83. The machine-readable medium of claim 82, wherein the menu of options includes an option to view the alternate content.

84. The machine-readable medium of claim 82, wherein the menu of options includes an option to view the alternate content in a Picture-In-Picture (PIP) mode.

85. The machine-readable medium of claim 82, wherein the menu of options includes an option to record the alternate content.

86. The machine-readable medium of claim 82, wherein the menu of options includes an option to request an email containing the alternate content.

87. A machine-readable medium having stored thereon a series of instructions, the instructions, when executed by a processor, cause the processor to:
receive a hot key signal from an interactive television service provider's network, the hot key signal indicating availability and a location of alternate content;
determine whether the hot key signal is relevant to a user viewing original content from the interactive television service provider;
responsive to determining the hot key signal is relevant to the user, display on a screen an indication that the hot key signal has been received;
responsive to receiving an indication that the hot key is accepted, present the alternate content to the user; and
responsive to the user finishing the alternate content, display on the screen a menu of options for returning from the alternate content.

88. The machine-readable medium of claim 87, wherein the menu of options includes an option to view content related to the alternate content.

89. The machine-readable medium of claim 87, wherein the menu of options includes an option to view content previously cached on a terminal device.

90. The machine-readable medium of claim 87, wherein the menu of options includes an option to view Video-On-Demand (VOD) content related to the alternate content.

91. The machine-readable medium of claim 87, wherein the menu of options includes an option to view web sites related to the alternate content.

92. The machine-readable medium of claim 87, wherein the menu of options includes an option to shop for items related to the alternate content.

93. The machine-readable medium of claim 87, wherein the menu of options includes an option to return to a previous channel.
